(19) United States
(12) Patent Application Publication
(10) Pub. No.: US 2011/0001416 A1
(43) Pub. Date: Jan. 6, 2011

(54) SHELVING UNIT, IN PARTICULAR FOR REFRIGERATED INSTALLATIONS

(75) Inventor: Eric Escalettes, Bordeaux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/921,546

(22) PCT Filed: Mar. 25, 2009
(86) PCT No.: PCT/FR2009/050518

§ 371 Date: Sep. 8, 2010

(30) Foreign Application Priority Data
Apr. 9, 2008 (FR) 0852391

(51) Int. Cl. F25D 25/02; A47B 96/02; B23P 11/02

(52) U.S. Cl. 312/408; 211/134; 29/447

(57) ABSTRACT

A shelving unit for a cabinet, for example a refrigerator or similar cabinet, including a panel supporting articles and a frame or part of a frame gripping the panel by its actual surrounding part, the frame configured to allow the shelving unit to be mounted in the chassis of the cabinet. At least one securing member for the panel is provided, including a part that is applied against a peripheral region of the bottom face of the panel in a position of use, and at least one fixing mechanism on the frame complementing a mechanism borne by the bottom face of the actual surround of the frame.

The present invention relates to a shelving unit or shelf for supporting articles, intended to be fixed or mounted, advantageously removably, in the chassis of a cabinet unit. In particular, it relates to a shelving unit able to be used in refrigerated compartments, such as refrigerated cabinets, refrigerating appliances, refrigerators, to support articles, in particular foodstuffs.

These shelving units comprise solid plates made of mineral or organic glass such as polycarbonate or poly(methyl methacrylate), monolithic or laminated, transparent, translucent or opaque, provided with a surround, total or partial, made of plastic material so as to avoid the risks of wounds from the sharp edges of the plates and/or to reinforce said plates.

Moreover, the edges of the surround made of plastic material can be straight and uniform or of more complex shape, being able in particular to present peripheral parts or extensions for functional or esthetic purposes. Thus, the front edge can form a handle for manipulating the shelving unit and the side and rear edges are generally adapted to cooperate with the chassis of the cabinet unit, which generally bears shelving support strips.

There are various methods of joining the surround made of plastic material to the panel, by encapsulation molding, or by adding a surround to the panel, for example by gluing, clipping or fitting sides of the surround or even by shrink-fitting the surround just after molding, the panel in this case being joined to the surround on leaving the mold before the plastic material has fully shrunk.

These shelving units give satisfaction by their practical and esthetic forms, and also by the fact that the joining methods, in particular by shrinkage, make it possible to obtain a good connection and, if necessary, a good seal-tightness between the glass panel and the surround made of plastic material.

The present invention addresses the shelving units for which the surround made of plastic material grips the rims of the panel, in particular by shrinkage, such shelving units having been described by the filing company in the international PCT applications WO 02/076268 A1 and WO 2006 059038 A1.

The surrounds of the shelving units described in this way comprise at least one flange towards the inside applied to the panel supporting articles on at least one of the two faces of said panel. In practice, a flange towards the inside is applied to all the perimeter of the top face of the panel, considered in the position of use. In this way, if liquid flows from foodstuffs positioned on the shelving unit, it is retained by the end vertical edge of this flange. Also, under the bottom face of the panel concerned in the position of use, a number of flanges of the surround are applied, taking the form of securing tabs distributed all around the perimeter of the panel.

In reality, it would be possible to do without these securing tabs, in particular in the case where the frame is applied to the panel by shrinkage, but it is preferable to provide them for safety reasons.

Thus, during manufacture, these securing tabs, produced by molding with the surround of the panel, prove to be a hindrance. In certain cases, the panel can be put in place without touching said tabs, in particular if the putting-into-place occurs very quickly after leaving the mold and therefore in a period when the frame is not yet in actual fact shrunk. In other cases, the manufacture of the shelving unit entails handling that is all the more difficult because the frame is hotter; this therefore means that automating the insertion of the glass panel into the frame made of plastic material is not possible.

The aim of the present invention is to remedy these drawbacks. To this end, provision is made for the securing of the panel under its bottom face to be performed by parts added by the operator, once the panel has been inserted into the frame. This insertion of the panel into the frame is performed without difficulty because of the absence of the above-mentioned flanges, and can therefore be automated.

The subject of the present invention is therefore a shelving unit for a cabinet, in particular for a refrigerator or similar, comprising a panel supporting articles and a frame or part of a frame gripping the panel by its actual surrounding part, said frame being arranged to allow said shelving unit to be mounted in the chassis of said cabinet, characterized in that at least one securing member for the panel is provided, comprising a part that is applied against a peripheral region of the bottom face of said panel in the position of use, and at least one fixing means on the frame complementing a means borne by the bottom face of the actual surround of said frame.

A fixing means comprises in particular a dog or boss borne by the bottom face of the surround of the frame and able to be inserted by force-fitting or snap-fitting into a corresponding hole formed in said securing member, said hole constituting the complementary fixing means, or, conversely, by a dog or boss borne by said securing member and able to be inserted by force-fitting or snap-fitting into a corresponding hole formed in the bottom face of the surround of the frame, said hole constituting the complementary fixing means.

The dog or boss can be cylindrical or tapered, the corresponding hole being respectively cylindrical or tapered.

The dog or boss can have on its periphery a succession of engaging teeth with triangular profile and the hole can have corresponding internal teeth.

According to particular embodiments, a securing member can take the form of a flat bar-type corner-tie piece or triangular corner, bearing a fixing means at both ends. In the case where the surround of the frame exceeds the rim of the panel on the side of the bottom face of the latter in the position of use, notches can then be formed in the bottom face of the frame to allow the securing member to pass, the fixing means being, for example, formed in the bottom of said notches.

In the case where the shelving unit comprises at least one securing member taking the form of a flat bar-type corner-tie piece, the fixing means can comprise dogs borne by the bar and corresponding holes formed in the frame, at least one of the holes being an oblong hole, the mean line of which is parallel to the corresponding edge of the frame. The presence of an oblong hole facilitates the position of the bar when mounting.

Still in the case where the surround of the frame exceeds the rim of the panel on the side of the bottom face of the latter in the position of use, a securing member can take the form of a triangular corner and have, on its face comprising the fixing means, a relief part intended to bear against the corner region of the bottom face of the panel in a position of use.

According to other particular embodiments, a securing member can take the form of a frame, a part of frame or a substantially flat bead, intended to be applied along a corresponding part of the frame, and comprising fixing members distributed along the latter.

In the case where the surround of the frame exceeds the rim of the panel on the side of the bottom face of the latter in the position of use, the securing member of frame, part of frame or bead type can include a square fold along the internal edge, to bear on the panel.

Also, in the case where the surround of the frame exceeds the rim of the panel on the side of the bottom face of the latter in the position of use, the securing member taking the form of a corner, a frame, part of a frame or a bead, the frame can comprise at least one lowered part to receive the securing member, the securing member being flat if the lowered part has a height equal to the thickness of the panel, and having an external flange if the lowered part has a height less than the thickness of the panel.

In the case where the bottom face of the panel is provided with an enameled edge, the securing member or members can be arranged in such a way that their part applied to the panel is located in the mounting position under the enameled edge.

Another subject of the invention is a method of manufacturing a shelving unit as defined hereinabove, characterized in that it comprises steps consisting in:
placing on a support the frame or the part of frame leaving the mold in the still-hot state, the frame being placed on its face that will be the top face in the position of use;
inserting the panel into the frame or the part of the frame still in the hot state;
fixing to the frame, if appropriate still in the hot state, the securing member or members for the panel;
leaving the frame to shrink.

Another subject of the invention is a cabinet unit, such as a refrigerated cabinet, refrigerating appliance or refrigerator comprising at least one shelving unit as defined hereinabove.

To better illustrate the shelving unit as claimed by the present invention, a particular embodiment thereof is described hereinbelow, with reference to the appended drawing.

In this drawing:

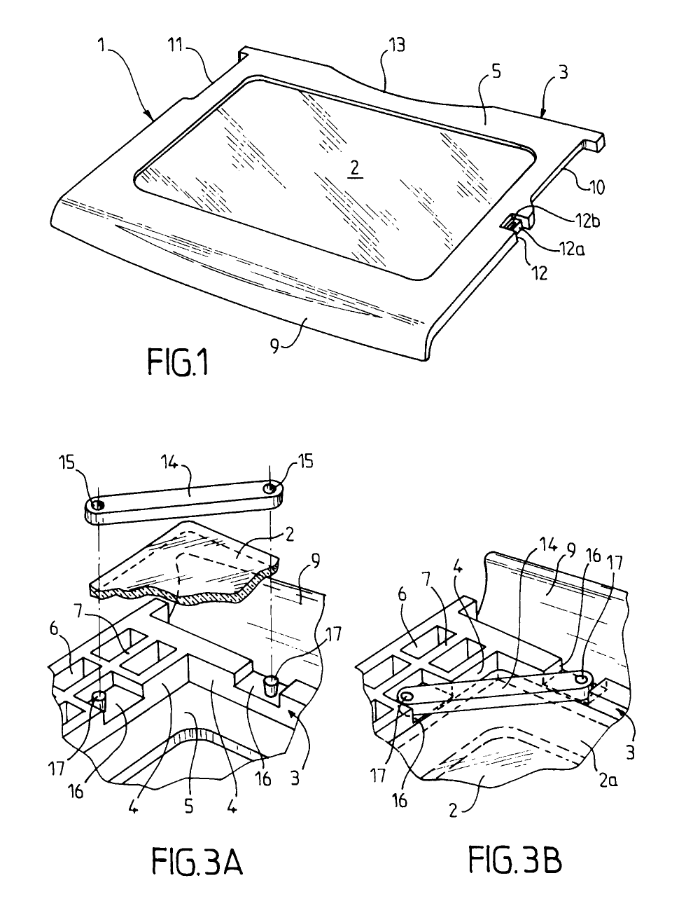

FIG. 1 is a perspective view of the shelving unit according to the present invention, showing the top face of the latter in the position of use;

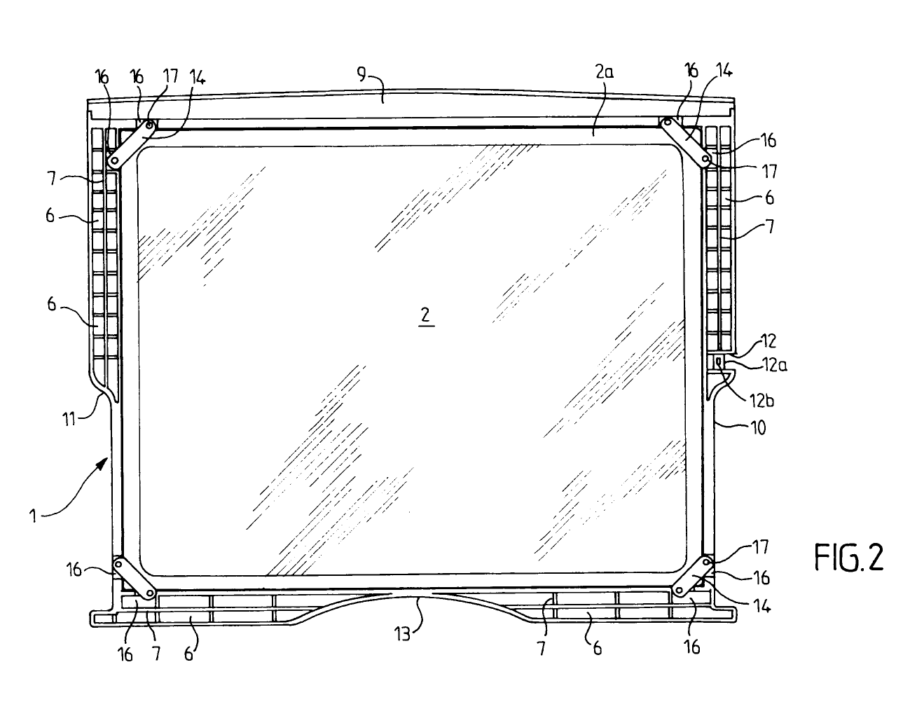

FIG. 2 is, on a larger scale, a bottom view of the shelving unit of FIG. 1, showing a securing member according to a first embodiment of the present invention;

FIG. 3A is an exploded partial view of the region of FIG. 2 located in the top left corner when looking at this figure, this view being represented exploded to show the mounting of the glass panel in its frame and the consolidation of this mounting according to the first embodiment;

FIG. 3B is a view similar to FIG. 3A, in the mounted state;

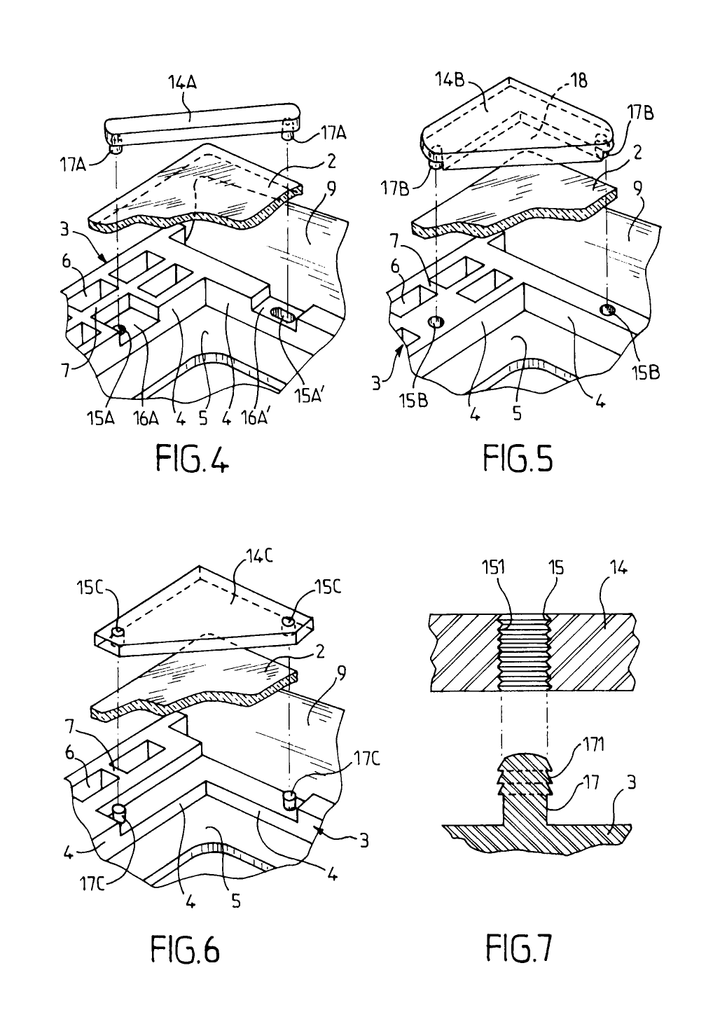

FIG. 4 is a view similar to FIG. 3A, illustrating a variant of this first embodiment;

FIG. 5 is a view similar to FIG. 3A, illustrating a second embodiment of the securing member according to the invention;

FIG. 6 is a view similar to FIG. 3A, illustrating a variant of this second embodiment;

FIG. 7 is a larger-scale view of a variant embodiment of the fixing means;

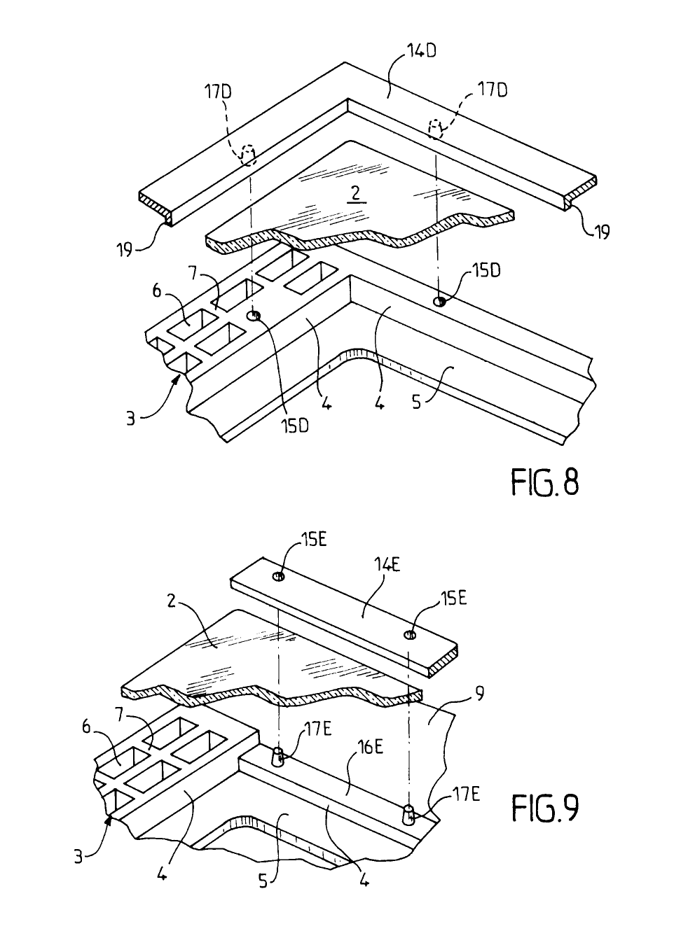

FIG. 8 is a view similar to FIG. 3A, illustrating a third embodiment of the inventive securing member; and

FIG. 9 is a view similar to FIG. 3A, illustrating a fourth embodiment of the inventive securing member.

Referring to FIGS. 1, 2, 3A and 3B, it can be seen that a shelving unit 1 for a refrigerator is represented. In the description that follows of this unit, the terms “front”, “rear”, “right”, “left”, “bottom”, “top”, “vertical”, “horizontal” and equivalent expressions will be used with reference to their position in place inside a refrigerator, with the user facing the shelving unit concerned.

The shelving unit 1 comprises a mineral or organic glass panel 2, rectangular, provided with a frame 3 made of a relatively rigid plastic material, such as polypropylene.

The frame 3, of generally rectangular and flattened form, comprises a surround part proper, having a vertical internal wall 4 (FIGS. 3A and 3B), rectangular, of a height greater than the thickness of the glass panel 2 and gripping the latter over its entire thickness in the mounting position (FIG. 4). The distance between the wall 4 and the rim of the glass panel 2 is reduced, to zero in particular, at least in certain places, which results from the chosen manufacturing method which will be described later. This fixing method ensures that the mounting is secure and seal-tight.

In its top part and over its entire perimeter, the frame 3 forms a flange 5 towards the inside, of small thickness, which is applied to the top face of the glass panel 2, its free edge forming, for example, a rectangle with rounded corners (FIG. 1). The top face of the flange 5 is located in the extension of the top face of the actual surround of the frame 3, in order to form a perfectly smooth frame top 3. The bottom face of the glass panel 2 can be provided with an enameled edge 2a for example corresponding to the top flange 5 (FIG. 2).

The bottom face of the frame 3 is not smooth like the top face, but has, in its right and left rear edge regions, cells 6 separated by ribs 7, which makes it possible to save on material in these regions while maintaining sufficient rigidity for the frame 3. These cells 6 and ribs 7 can be obtained by the technique known as air molding.

To complete the description of the shelving unit 1, it can be indicated that:
the frame 3 is folded downward in its front part at 9 in order to form a handle for manipulating the shelving unit 1;
the right and left edges of the shelving unit 1 have, in the rear region, elongate notches with curved edges respectively 10 and 11, the right edge also having in its central part a U-shaped notch 12, the bottom of which has a rib 12a provided with a central hole 12b of axis parallel to the internal edge 4 of the frame 3;
the rear edge of the shelving unit 1 has a central notch 13 in arc of circle form.

The role of these particularly-shaped cutouts in the edges of the shelving unit 1 depends on the chassis and the support structure (such as support strip) of said shelving unit 1 in the refrigerator, and its method of insertion and removal (thus, it is commonplace to provide, for safety reasons, for the shelving unit not to be able to be fully withdrawn directly, it being first withdrawn over only a part of the latter). Since they are not a concern of the present invention and only particular examples, these cutouts and details will not be described further here.

Four corner-tie bars 14 consolidate the fixing of the panel 2 to the bottom face of the shelving unit.

Each bar 14 comprises a strut taking the form of an elongate rectangle with rounded ends, made of a relatively rigid plastic material. It comprises, in the vicinity of each of its ends, a cylindrical through-hole 15 of axis perpendicular to the plane of the bar 14. Notches 16 are formed in the bottom face of the frame 2, either side of each corner of the latter, extending into the wall 4. The depth of each of these notches 16 is roughly equal to the height of the bars 14. The height of the vertical wall 4 extending above the frame 3 at the level of the notches 16 is roughly equal to the thickness of the panel 2. Moreover, the length and the width of the notches 16 is such that a bar 14 can be positioned by being applied by its central region against the panel 2 and by its two ends onto the bottoms of the two notches 16 adjacent to one and the same corner, a dog 17 standing proud on the bottom of each notch 16 that force-fits into a facing hole 15 of the bar 14 in order to ensure the fixing of the latter.

Moreover, as can be seen in FIG. 7, the dog 17 could have on its periphery a succession of locking teeth 171 of triangular profile, the associated hole 15 having corresponding internal teeth 151.

FIG. 4 shows a bar 14A made in accordance with a variant of the bar 14. According to this variant, the dogs 17A are borne by the bar and the corresponding holes are blind holes 15A, 15A′ formed in the bottom of the notches 16A, 16A′ of the frame 3. One of the holes (15A′) is a hole that is no longer cylindrical but oblong, extending along the corresponding edge of the frame 3, and the notch 16A′ being made longer accordingly.

The presence of the oblong hole 15A′ makes it possible to position the bar 14A more easily, as long as this positioning is performed when the frame 3 is hot, not yet fully shrunk.

FIG. 5 shows another embodiment according to which the bar 14A is replaced by a triangular corner piece 14B, the edges of which are rounded at the peaks of the two acute angles. Blind holes 15B are formed in the vicinity of each of the corners of the frame 3, opening into the outer face of the latter. The piece 14B, bears, on one of its faces, the dogs 17B intended to cooperate with the holes 15B, and a relief part 18 intended to bear on the panel 2 in the mounting position.

FIG. 6 illustrates another triangular corner piece 14B, flat, with through-holes 15C formed in the vicinity of each of the acute angle peaks of said piece 14C, which are moreover truncated in order to allow the piece 14C to be put in place. To this end, a corner notch 16C is formed in the frame 3, dogs 17C being formed projecting proud in the vicinity of each of the edges of said notch 16C in order to cooperate with the holes 15C. The dimensions of the piece 14C and of the notch 16C are calculated so that, in the mounting position, the piece 14C bears by its two perpendicular edges on the bottom of the notch 16C and by its remaining part on the panel 3, its external face being placed in the extension of the external face of the frame 3.

FIG. 8 shows another means of securing the panel 2 in the frame 3 in the bottom part of the shelving unit. This other securing means consists of a flat rectangular frame 14D bearing occasional dogs 17D on one of its faces, the latter also having a square return 19 along its bottom edge.

The dogs 17D are intended to penetrate into blind holes 15D formed in a corresponding fashion in the free face of the frame 3.

In the mounting position, the frame 14D bears on the panel 3 by the free edge of the square return 19.

In FIG. 9, another means of securing the panel 2 in the frame 3 is represented, consisting of a flat bead 14E in which are formed, from place to place, through-holes 15E, and which is intended to be applied and be fixed against the lowered top face of one side of the frame 3. To this end, dogs 17E are borne by this top face to match with the holes 15E. The bead 14E is wider than this face so that it can be applied to the panel 2. In this position, the top face of the bead 14E is flush with the rest of the frame 3.

The shelving unit 1 that has just been described is obtained by formation of the frame 3 made of plastic material by hot molding, the glass panel 2 being joined to the frame 3 on leaving the mold before the plastic material has fully shrunk. Details concerning this method (temperatures, step times, etc.) will be found in the international PCT application WO 02/076268 A1 in the name of the filing company.

For the mounting of the shelving unit 1, the frame 3, still hot, is placed on a support by its face comprising the flange 5 (top face in the position of use), and the panel 2 is put in place before the frame is fully shrunk. Positioning is easy, because the frame 3 has no flange on its bottom face.

A perfect joining of the assembly is obtained in this way, because the panel 2 is gripped by the frame 3 in a seal-tight manner. This is of great practical importance, since the shelving unit 1 is intended to support foodstuffs which can spill and slip into plastic-glass material junction areas, prejudicing the correct use of the refrigerator.

The assembly is then reinforced by the placement, by force-fitting or snap-fitting, of at least one securing means according to the invention 14, 14A, 14B, 14C, 14D or 14E, this placement being able to take place when the frame is still hot, in particular if oblong holes, like the hole 15A′, have been provided in the case of bar-type securing members. Furthermore, a welding or a gluing of the bar fixings can further reinforce the join.

Obviously, the embodiments that have just been described have been given as a non-limiting indication and modifications can be made without in any way departing from the context of the present invention.

1-14. (canceled)

15. A shelving unit for a cabinet, comprising:
a panel supporting articles and a frame or part of a frame gripping the panel by its actual surrounding part, the frame configured to allow the shelving unit to be mounted in a chassis of a cabinet; and
at least one securing member for the panel, comprising a part that is applied against a peripheral region of a bottom face of the panel in a position of use, and at least one fixing means on the frame complementing a means borne by a bottom face of the actual surrounding part of the frame.

16. The shelving unit as claimed in claim 15, wherein a fixing means comprises a dog or boss borne by the bottom face of the surrounding part of the frame and is configured to be inserted by force-fitting or snap-fitting into a corresponding hole formed in the securing member, the hole constituting the complementing fixing means or, conversely, by a dog or boss borne by the securing member and configured to be inserted by force-fitting or snap-fitting into a corresponding hole formed in the bottom face of the surrounding part of the frame, the hole constituting the complementing fixing means.

17. The shelving unit as claimed in claim 16, wherein the dog or boss is cylindrical or tapered, the corresponding hole being respectively cylindrical or tapered.

18. The shelving unit as claimed in claim 17, wherein the dog or boss includes on its periphery a succession of engaging teeth with triangular profile and the hole includes corresponding internal teeth.

19. The shelving unit as claimed in claim 15, wherein the securing member takes a form of a flat bar-type corner-tie piece or triangular corner, bearing a fixing means at both ends.

20. The shelving unit as claimed in claim 19, in which the surrounding part of the frame exceeds a rim of the panel on the side of the bottom face of the panel in the position of use, wherein notches are formed in the bottom face of the frame to allow the securing member to pass, the fixing means being formed in the bottom of the notches.

21. The shelving unit as claimed in claim 19, comprising at least one securing member taking a form of a flat bar-type corner-tie piece, wherein the fixing means comprises dogs borne by the bar and corresponding holes formed in the frame, at least one of the holes being an oblong hole, a mean line of which is parallel to the corresponding edge of the frame.

22. The shelving unit as claimed in claim 19, in which the surrounding part of the frame exceeds a rim of the panel on the side of the bottom face of the panel in the position of use, wherein a securing member takes a form of a triangular corner and includes, on its face comprising the fixing means, a relief part configured to bear against a corner region of the bottom face of the panel in a position of use.

23. The shelving unit as claimed in claim 15, wherein a securing member takes a form of a frame, a part of frame or a bead, substantially flat, configured to be applied along a corresponding part of the frame, and comprising fixing members distributed along the frame.

24. The shelving unit as claimed in claim 23, in which the surrounding part of the frame exceeds a rim of the panel on the side of the bottom face of the panel in the position of use, wherein the securing member of frame, part of frame or bead type comprises a square fold along its internal edge, to bear on the panel.

25. The shelving unit as claimed in claim 19, in which the surrounding part of the frame exceeds a rim of the panel on the side of the bottom face of the panel in the position of use, the securing member taking a form of a corner, a frame, part of a frame or a bead, wherein the frame comprises at least one lowered part to receive the securing member, the securing member being flat if the lowered part has a height equal to the thickness of the panel, and including an external flange if the lowered part has a height less than the thickness of the panel.

26. The shelving unit as claimed in claim 15, in which the bottom face of the panel includes an enameled edge, wherein the securing member or members is/are arranged such that their part applied to the panel is located in the mounting position under the enameled edge.

27. A method of manufacturing the shelving unit as defined in claim 15, comprising:
placing on a support the frame or the part of frame leaving a mold in the still-hot state, the frame being placed on its face that will be the top face in the position of use;
inserting the panel into a frame or the part of the frame still in the hot state;
fixing to the frame, if appropriate still in the hot state, the securing member or members for the panel;
leaving the frame to shrink.

28. A cabinet unit, or a refrigerated cabinet, refrigerating appliance, or refrigerator, comprising at least one shelving unit as defined in claim 15.
